(19) United States
(12) Patent Application Publication
(10) Pub. No.: US 2025/0333562 A1
(43) Pub. Date: Oct. 30, 2025

(54) PHENOLIC EPOXY RESIN AND METHOD FOR MANUFACTURING THE SAME

(71) Applicant: NAN YA PLASTICS CORPORATION, TAIPEI (TW)

(72) Inventors: CHING-YAO YUAN, TAIPEI (TW); CHUNG-YU CHEN, TAIPEI (TW); CHEN-HUA WU, TAIPEI (TW); JUNG-TSU WU, TAIPEI (TW)

(21) Appl. No.: 18/751,072

(22) Filed: Jun. 21, 2024

(30) Foreign Application Priority Data
Apr. 29, 2024 (TW) 113115886

(51) Int. Cl. C08G 59/02; C08G 59/06; C08G 59/68

(52) U.S. Cl. CPC C08G 59/022; C08G 59/025; C08G 59/063; C08G 59/682

(57) ABSTRACT

A phenolic epoxy resin and a method for manufacturing the same are provided. The method for manufacturing the phenolic epoxy resin includes: reacting cardanol and vanillin for a polycondensation reaction at a temperature ranging from 60° C. to 90° C. so as to form a phenolic resin; injecting the phenolic resin, epichlorohydrin, and a surfactant into a reactor; adding a first basic solution for a dehydration reaction at a temperature ranging from 55° C. to 65° C.; when an equivalent of a hydroxyl group of the phenolic resin is lower than 3% of the original equivalent of the hydroxyl group of the phenolic resin, adding a second basic solution for a ring-closure reaction at a temperature ranging from 60° C. to 70° C., so as to obtain a phenolic epoxy resin. The surfactant is an alcohol ether solvent.

### CROSS-REFERENCE TO RELATED PATENT APPLICATION

This application claims the benefit of priority to Taiwan Patent Application No. 113115886, filed on Apr. 29, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a phenolic epoxy resin and a method for manufacturing a phenolic epoxy resin, and more particularly to a phenolic epoxy resin formed from a biomass material and a method for manufacturing a phenolic epoxy resin.

### BACKGROUND OF THE DISCLOSURE

A thermosetting epoxy resin has excellent performance in various properties, thereby having a wide range of applications in coating, adhesive, encapsulating adhesive, and composite materials. However, the main sources of the thermosetting epoxy resin are petrochemicals.

Taking bisphenol epoxy resin, which currently has the highest productive yield, for example, a mature biomass technology of epichlorohydrin, which is the key material for forming the bisphenol epoxy resin, has been developed, but a source of bisphenol still comes from a cracking of petroleum. In addition, bisphenol is known to be biologically toxic. Hence, many countries have explicitly prohibited the use of bisphenol in materials from coming in contact with food or human body.

Therefore, due to petroleum shortages, the rising of environmental awareness, and the limitation of biological toxicity, research units are committed to finding monomers to replace bisphenol, so as to overcome the problems mentioned above. In addition, epoxy resin that is completely formed from the biomass better contributes to environmental protection.

Accordingly, how to manufacture the epoxy resin formed from biomass materials by improving raw materials to overcome said problems has become an important issue to be addressed in the relevant industry.

### SUMMARY OF THE DISCLOSURE

In response to the above-referenced technical inadequacy, the present disclosure provides a phenolic epoxy resin and a method for manufacturing a phenolic epoxy resin.

In order to solve the above-mentioned problems, one of the technical aspects adopted by the present disclosure is to provide a method for manufacturing a phenolic epoxy resin. The method for manufacturing the phenolic epoxy resin includes: reacting cardanol and vanillin for a polycondensation reaction at a temperature ranging from 60° C. to 90° C. so as to form a phenolic resin; injecting the phenolic resin, epichlorohydrin, and a surfactant into a reactor; adding a first basic solution for a dehydration reaction at a temperature ranging from 55° C. to 65° C.; when an equivalent of a hydroxyl group of the phenolic resin is lower than 3% of the original equivalent of the hydroxyl group of the phenolic resin, adding a second basic solution for a ring-closure reaction at a temperature ranging from 60° C. to 70° C., so as to generate a phenolic epoxy resin. The surfactant is an alcohol ether solvent.

In one of the possible or preferred embodiments, based on a total weight of the phenolic resin being 100 phr, an addition amount of the epichlorohydrin ranges from 400 phr to 800 phr.

In one of the possible or preferred embodiments, a molecular weight of the phenolic resin ranges from 4,000 g/mol to 10,000 g/mol.

In one of the possible or preferred embodiments, the surfactant is selected from the group consisting of: ethylene glycol monomethyl ether, diethylene glycol monomethyl ether, triethylene glycol monomethyl ether, diethylene glycol monoethyl ether, diethylene glycol monobutyl ether, propylene glycol monomethyl ether, and propylene glycol monoethyl ether.

In one of the possible or preferred embodiments, the first basic solution is added in a dropwise manner, and a total dripping time of the first basic solution ranges from 1.5 hours to 3.5 hours.

In one of the possible or preferred embodiments, the second basic solution is added in a dropwise manner, and a total dripping time of the second basic solution ranges from 1 hour to 2.5 hours.

In one of the possible or preferred embodiments, after the dehydration reaction, the reactor is heated to over 65° C., and a pressure in the reactor ranges from 5 Torr to 400 Torr for dehydration.

In one of the possible or preferred embodiments, after the ring-closure reaction, the reactor is heated to over 75° C., and a pressure in the reactor ranges from 5 Torr to 400 Torr for dehydration.

In one of the possible or preferred embodiments, after the dehydration, the epichlorohydrin remained in the reactor is removed at a temperature ranging from 120° C. to 130° C.

In one of the possible or preferred embodiments, after removing the epichlorohydrin, an extract solvent is added into the reactor at a temperature ranging from 70° C. to 80° C., so as to obtain the phenolic epoxy resin.

In one of the possible or preferred embodiments, the extract solvent is selected from the group consisting of: ethyl acetate, toluene, and methyl isobutyl ketone.

In one of the possible or preferred embodiments, an equivalent of an epoxy group of the phenolic epoxy resin ranges from 250 g/equivalent to 350 g/equivalent.

In one of the possible or preferred embodiments, a viscosity of the phenolic epoxy resin ranges from 10,000 cps to 15,000 cps.

In order to solve the above-mentioned problems, another one of the technical aspects adopted by the present disclosure is to provide a phenolic epoxy resin formed from the method mentioned above.

Therefore, in the phenolic epoxy resin and the method for manufacturing a phenolic epoxy resin provided by the present disclosure, by virtue of “injecting the phenolic resin, epichlorohydrin, and a surfactant into a reactor,” “adding a first basic solution for a dehydration reaction at a temperature ranging from 55° C. to 65° C.,” and “adding a second basic solution for a ring-closure reaction at a temperature ranging from 60° C. to 70° C.,” the phenol epoxy resin completely formed from biomass material can be obtained and can be used to replace the phenol epoxy resin formed from petroleum-cracking materials.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a flowchart of a method for manufacturing a phenol epoxy resin according to the present disclosure; and

FIG. 2 is a reaction mechanism schematic view between the phenolic resin and epichlorohydrin resin according to the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

In order to overcome the problems of biological toxicity of the raw materials and the petroleum shortage, the present disclosure provides a phenolic epoxy resin completely formed from biomass material through the selection of monomers, so as to contribute to environmental protection. Moreover, operating parameters of the synthesis process are adjusted after the selection of the specific biomass materials, so as to synthesize the material having commercial exploitability.

Specifically, cardanol and vanillin are selected to be raw materials for a polycondensation reaction to form a phenolic resin (through steps S1 to S5). The phenolic resin is further reacted with epichlorohydrin for a substitution reaction (through steps S6 to S10), so as to obtain the phenolic epoxy resin completely formed from biomass materials. Therefore, the phenolic epoxy resin of the present disclosure can be used to replace the conventional bisphenol A based epoxy resin.

Cardanol and vanillin are both derived from biomass materials. Cardanol can be used to replace commonly used phenol (for example: bisphenol A). Vanillin can be used to replace toxic formaldehyde. Therefore, a structural formula of the phenolic epoxy resin of the present disclosure can be represented as:

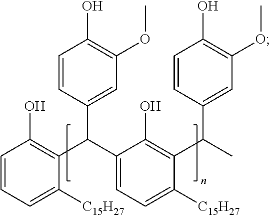

where “n” is an integer ranging from 5 to 25.

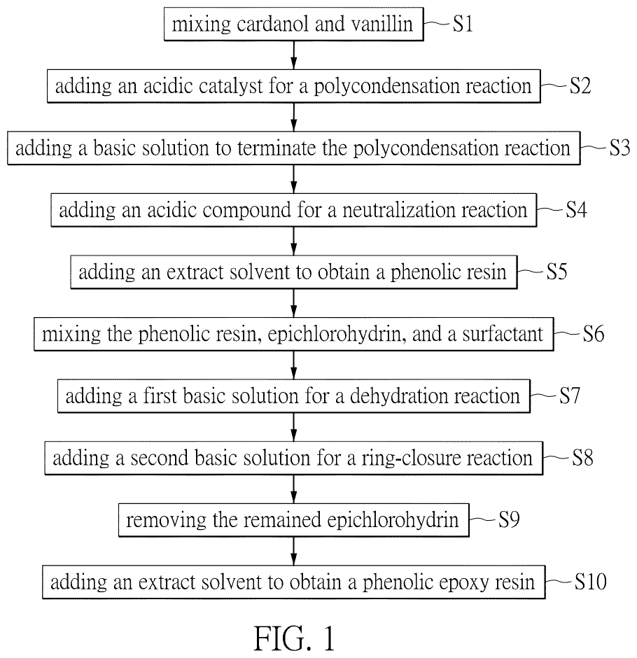

Referring to FIG. 1, the method for manufacturing the phenolic epoxy resin of the present disclosure includes steps of: mixing cardanol and vanillin (step S1), adding an acidic catalyst for a polycondensation reaction (step S2); adding a basic solution to terminate the polycondensation reaction (step S3); adding an acidic compound for a neutralization reaction (step S4); adding an extract solvent to obtain a phenolic resin (step S5); mixing the phenolic resin, epichlorohydrin, and a surfactant (step S6); adding a first basic solution for a dehydration reaction (step S7); adding a second basic solution for a ring-closure reaction (step S8); removing the remained epichlorohydrin (step S9); adding an extract solvent to obtain a phenolic epoxy resin (step S10).

In step S1, cardanol and vanillin are added into a reactor. Vanillin is a limited agent. In other words, a molar amount of the cardanol is higher than a molar amount of the vanillin. In this way, two terminal groups of the phenolic resin can be ensured to have hydroxyl groups which are beneficial for the subsequent substitution reaction.

In an exemplary embodiment, in order to ensure the specificity of the reaction, nitrogen can be introduced into the reactor, such that the cardanol and the vanillin can be reacted under a nitrogen atmosphere.

In step S2, in order to accelerate the polycondensation reaction, the reactor is heated to a temperature ranging from 60° C. to 90° C., and the acidic catalyst is added, such that the phenolic resin can be obtained from the cardanol and the vanillin through the polycondensation reaction.

It should be noted that a conventional acidic catalyst used for the polycondensation reaction between formaldehyde and phenol is weak acids. Since the cardanol and the vanillin have low reactivity, strong acids are selected to be used as the acidic catalyst, which facilitates the polycondensation reaction. Specifically, an acidity coefficient pKa value of the acidic catalyst at 25° C. in water used in the present disclosure is lower than 3.1.

When the acidity coefficient pKa value of the acidic catalyst is low (such as when hydrochloric acid, sulfuric acid, or phosphoric acid is used), more hydrogen ions can be dissociated from the acidic catalyst. The polycondensation reaction is severely catalyzed by the abundant hydrogen ions such as to generate a lot of heat, which causes the polycondensation reaction to be difficult to control. As a result, the phenolic resin has a wide molecular weight distribution range, that is, a high polymer dispersion index.

When the acidity coefficient pKa value of the acidic catalyst is high (such as when citric acid or oxalic acid is used), few hydrogen ions are dissociated from the acidic catalyst. Hence, the reactivity between the cardanol and the vanillin is weak, and the phenolic resin having a low molecular weight will be obtained.

After experimental testing, the acidity coefficient pKa value of the acidic catalyst at 25° C. in water can range from −2.9 to 1.5, and preferably from −2.0 to −1.5. For example, the acidic catalyst can be methanesulfonic acid or p-toluenesulfonic acid, preferably is methanesulfonic acid.

In order to control the reactive stability of the polycondensation reaction, in addition to the temperature and the types of the acidic catalyst, an amount of the acidic catalyst is also controlled. Based on a total weight of the cardanol and the vanillin being 100 parts by weight, the amount of the acidic catalyst can range from 0.25 parts by weight to 1 part by weight, and preferably from 0.5 parts by weight to 0.6 parts by weight.

In step S3, an amount of the vanillin in the reactor is measured by liquid chromatograph (LC). When a concentration of the vanillin in the reactor is lower than 0.1 wt %, the basic solution is added into the reactor to terminate the polycondensation reaction. In an exemplary embodiment, a duration of the polycondensation reaction in step S2 is approximately 3.5 hours to 4.5 hours.

Specifically, the addition of the basic solution can neutralize the acidic catalyst so as to achieve the effect of terminating the polycondensation reaction. The basic solution can be a 40 wt % to 60 wt % sodium hydroxide aqueous solution or a 40 wt % to 60 wt % potassium hydroxide aqueous solution, but the present disclosure is not limited thereto.

In step S4, the addition of the acidic compound can adjust the pH value of the solution to become neutral (pH value ranging from 6.5 to 7.5) and prevent the formed phenolic resin from alkaline lysis. For example, the acidic compound can be oxalic acid. However, the addition amount of the acidic compound is not limited. The main purpose of the addition of the acidic compound is to maintain the pH value in the reactor to be neutral.

According to steps S1 to S4 mentioned above, various organic components and aqueous components are contained in the reactor, such that the phenolic resin can be washed and purified by extraction.

In step S5, after being washed by the extract solvent, an organic phase and an aqueous phase are formed in the reactor, and the phenolic resin is in the organic phase. Therefore, the aqueous phase can be removed under a reflow process at 110° C. to 130° C., and then the extract solvent can be removed at a pressure ranging from 5 Torr to 400 Torr, so as to obtain the phenolic resin.

After experimental testing, the extract solvent can be selected from the group consisting of ethyl acetate, toluene, and methyl isobutyl ketone. When the extract solvent is the above components, in which methyl isobutyl ketone is preferable, a better extraction effect of the phenolic resin can be achieved.

The cardanol in different purities are also tested. According to results, the higher the purity of the cardanol is, the lighter color of the phenolic resin will be. Specifically, the phenolic resin formed from the cardanol with the purity of higher than or equal to 87% (model: CardoliteR NX-2024) has a darker color; while, the phenolic resin formed from the cardanol with the purity of higher than or equal to 96% (model: CardoliteR NX-2026) has a lighter color.

In step S6, the phenolic resin obtained in the step S5, the epichlorohydrin, and the surfactant are mixed. The surfactant can help enhance a compatibility between the phenolic resin and the epichlorohydrin, and further facilitate the substitution reaction between the phenolic resin and the epichlorohydrin, so as to replace the hydroxy group of the phenolic resin with the epoxy group.

Specifically, the surfactant can be an ether alcohol solvent. For example, the surfactant can be selected from the group consisting of: ethylene glycol monomethyl ether, diethylene glycol monomethyl ether, triethylene glycol monomethyl ether, diethylene glycol monoethyl ether, diethylene glycol monobutyl ether, propylene glycol monomethyl ether, and propylene glycol monoethyl ether.

In an exemplary embodiment, relative to 100 parts by weight of the phenolic resin, the amount of the epichlorohydrin can be 400 parts by weight to 800 parts by weight. For example, the amount of the epichlorohydrin can be 450 parts by weight, 500 parts by weight, 550 parts by weight, 600 parts by weight, 650 parts by weight, 700 parts by weight, or 750 parts by weight. Preferably, relative to 100 parts by weight of the phenolic resin, the amount of the epichlorohydrin is 600 parts by weight to 700 parts by weight.

In steps S7 and S8, the reactor is heated to a temperature ranging from 55° C. to 70° C., and the first basic solution and the second basic solution are sequentially added respectively for the dehydrogenation reaction and the ring-closure reaction, so as to obtain the phenolic epoxy resin. In an exemplary embodiment, the temperature of the ring-closure reaction is higher than the temperature of the dehydrogenation reaction, and a temperature difference between the ring-closure reaction and the dehydrogenation reaction ranges from 5° C. to 10° C.

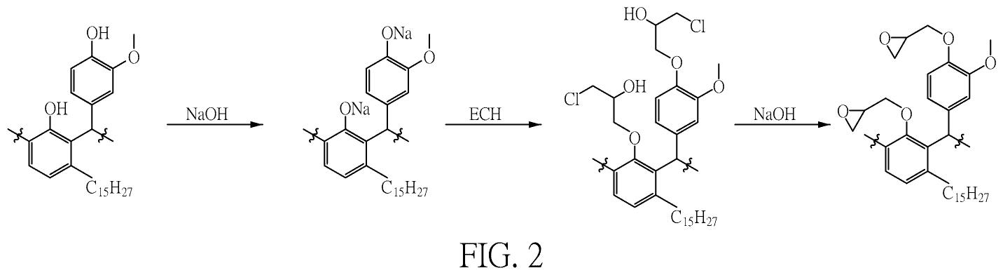

Referring to FIG. 2, the reaction mechanism between the phenolic resin and the epichlorohydrin in steps S7 and S8 are illustrated in FIG. 2. In the embodiment shown in FIG. 2, the first basic solution is a 50 wt % sodium hydroxide aqueous solution which facilitates removal of the hydrogen atom on the hydroxyl group of the phenolic resin. In the presence of the surfactant, the reaction between the epichlorohydrin and the phenolic resin is facilitated, such that the hydroxy group of the phenolic resin can be replaced with the epoxy group. The second basic solution is a 50 wt % sodium hydroxide aqueous solution which helps epichlorohydrin dechlorinate and close the ring to complete the substitution reaction.

The types of the first basic solution and the second basic solution are not limited thereto. The first basic solution and the second basic solution can be the same or different. For example, the first basic solution and the second basic solution can independently be a 50% potassium hydroxide aqueous solution.

In an exemplary embodiment, the addition amount of the first basic solution is higher than the addition amount of the second basic solution. For example, a ratio of the addition amount of the first basic solution to the second basic solution ranges from 2.5 to 4.

In step S7, the reactor is heated to a temperature ranging from 55° C. to 65° C., and then the first basic solution is added dropwise into the reactor for the dehydrogenation reaction, so as to remove the hydrogen atom of the hydroxy group (dehydrogenate) of the phenolic resin. For example, a dripping rate of the first basic solution ranges from 0.1 g/min to 0.4 g/min. In order to observe the reaction extent of the dehydrogenation reaction, the phenolic resin is exposed to a UV light having a wavelength of 310 nm, and an absorption value is measured so as to quantify the amount of the hydroxyl group in the phenolic resin. When an equivalent of a hydroxyl group of the phenolic resin is lower than 3% of the original equivalent of the hydroxyl group of the phenolic resin, the second basic solution is added for proceeding the step S8.

In an exemplary embodiment, a total dripping time of the first basic solution ranged from 1.5 hours to 3.5 hours, such that the duration of the dehydrogenation reaction is roughly conducted for 1.5 hours to 3.5 hours. After adding the first basic solution, the reactants are stirred for 30 minutes to ensure that the hydrogen atom on the hydroxy group of the phenolic resin is completely dehydrogenated. Subsequently, the product is dehydrated under a temperature of 65° C. and a pressure ranging from 5 Torr to 400 Torr for 30 minutes. During the dehydrogenation reaction, water is generated. A presence of water will cause the phenolic resin to hydrolyze. Therefore, after the dehydrogenation reaction, a dehydration treatment is performed before the step S8.

In step S8, the reactor is heated to a temperature ranging from 60° C. to 70° C., and then the second basic solution is added dropwise for the ring-closure reaction, so as to dechlorinate and close the ring of the epichlorohydrin. For example, a dripping rate of the second basic solution ranges from 0.05 g/min to 0.15 g/min. In an exemplary embodiment, a total dripping time of the second basic solution ranges from 1 hour to 2.5 hours, such that the duration of the ring-closure reaction approximately ranges from 1 hour to 2.5 hours. After the second basic solution is added, the temperature of the reactor is raised to 75° C., and a dehydration treatment is conducted for 30 minutes.

In step S9, the unreacted epichlorohydrin is removed at a temperature ranging from 120° C. to 130° C. to prevent the residue of the epichlorohydrin decreases the purity of the phenolic epoxy resin.

In step S10, when the reactor is cooled to 70° C. to 80° C., the extract solvent and the neutralizing solution are added at a normal pressure to wash the product. Accordingly, an organic phase and an aqueous phase are formed. The extract solvent can extract the phenolic epoxy resin into the organic phase, and the neutralizing solution can form sodium chloride salts with the chloride ions dechlorinated from the epichlorohydrin. Subsequently, the product is refluxed and dehydrated at a temperature ranging from 110° C. to 130° C. to remove the aqueous phase, and then the extract solvent is removed at a pressure ranging from 5 Torr to 400 Torr, so as to obtain the phenolic epoxy resin.

After experimental test, the extract solvent can be selected from the group consisting of ethyl acetate, toluene, and methyl isobutyl ketone, in which methyl isobutyl ketone is preferable. The neutralizing solution can be a 35 wt % sodium hydroxide aqueous solution. However, the present disclosure is not limited thereto.

### Polymerization of Phenolic Epoxy Resin

In order to prove the method of the present disclosure can manufacture the phenolic epoxy resin, the phenolic resins of Examples 1 to 3 are prepared according to the steps S1 to S5. After the preparation, a weight average molecular weight of the phenolic resin is measured by a gas chromatography permeability analyzer (GPC), and a hydroxyl equivalent of the phenolic resin is measured by an automatic potentiometric titration. The results are listed in Table 1.

According to the steps S6 to S10, the phenolic resin in Example 1, the epichlorohydrin, and the surfactant are mixed to form the phenolic epoxy resin in Examples 4 to 6. After the preparation, an epoxy equivalent of the phenolic epoxy resin is measured by an automatic potentiometric titration, and a viscosity of the phenolic epoxy resin at 25° C. is measured by a viscometer. The results are listed in Table 2.

### Example 1

190 g (equivalent being 0.63 mole) of cardanol and 76 g (equivalent being 0.5 mole) of vanillin are added into a reactor. Nitrogen gas is injected into the reactor so as to maintain a nitrogen atmosphere in the reactor. The reactor is heated. When a temperature of the reactor reaches 70° C., 1.5 g of methanesulfonic acid (acid catalyst) is added into the reactor so as to implement a polycondensation reaction for 4 hours.

After the polycondensation reaction, 1 g of 50 wt % sodium hydroxide aqueous solution (basic solution) and 0.1 g of oxalic acid (acidic compound) are added so as to terminate the polycondensation reaction, and methyl isobutyl ketone (extraction solvent) is added for extraction and washing. Subsequently, the reactor is heated to 120° C. for refluxing and dehydration. Then, the reactor is vacuumed at 10 Torr to evacuate the extract solvent, so as to obtain the phenolic resin.

The phenolic resin in Example 1 is a light yellow liquid, the weight average molecular weight of the phenolic resin is 7,406 g/mol, and the hydroxyl equivalent of the phenolic resin is 230 g/equivalent.

### Example 2

The operating conditions in Example 2 are similar to the operating conditions in Example 1. The difference is that the polycondensation reaction is implemented at 65° C. The phenolic resin in Example 2 is a light yellow liquid, the weight average molecular weight of the phenolic resin is 5,329 g/mol, and the hydroxyl equivalent of the phenolic resin is 242 g/equivalent.

### Example 3

The operating conditions in Example 3 are similar to the operating conditions in Example 1. The difference is that the polycondensation reaction is implemented at 85° C. The phenolic resin in Example 3 is a light yellow liquid, the weight average molecular weight of the phenolic resin is 9,593 g/mol, and the hydroxyl equivalent of the phenolic resin is 223 g/equivalent.

TABLE 1

| | | Example 1 | Example 2 | Example 3 |
|---|---|---|---|---|
| Temperature of polyconden- | | 70 | 65 | 85 |
| sation reaction (° C.) | | | | |
| Phenolic | weight average molecular | 7406 | 5329 | 9593 |
| resin | weight (g/mol) | | | |
| | hydroxyl equivalent | 230 | 242 | 223 |
| | (g/equivalent) | | | |

According to the results in Table 1, cardanol and vanillin can be used as the raw materials for the biomass phenolic resin according to steps S1 to S5 of the present disclosure. In addition, the weight average molecular weight of the phenolic resin will increase as the temperature of the polycondensation reaction increases. When the temperature of the polycondensation reaction ranges from 60° C. to 90° C., the weight average molecular weight of the phenolic resin can range from 4,000 g/mol to 10,000 g/mol. In other embodiments, the temperature of the polycondensation reaction can be integers between 60° C. and 90° C., and the weight average molecular weight of the phenolic resin can be integers between 4,000 g/mol and 10,000 g/mol. The hydroxyl equivalent of the phenolic resin can be 200 g/equivalent to 250 g/equivalent, such as 210 g/equivalent, 220 g/equivalent, 230 g/equivalent, or 240 g/equivalent.

### Example 4

150 g of the phenolic resin obtained in Example 1, 990 g of epichlorohydrin, and 125 g of diethylene glycol monomethyl ether (the surfactant) are added into the reactor.

When the reactor is heated to reach 60° C., 99 g of 50 wt % sodium hydroxide aqueous solution (the first basic solution) is added dropwise for dehydrogenation reaction, and a total dripping time is 2.5 hours. After the addition, the reactant is stirred for 30 minutes to ensure that the phenolic resin has been completely hydrogenated. After the temperature of the reactor is heated to reach 65° C., the reactant is vacuumed at 190 Torr for dehydration and conducted for 30 minutes.

Subsequently, 33 g of 50 wt % sodium hydroxide aqueous solution (the second basic solution) is added dropwise for ring-closure reaction and conducted for 2 hours. After the completeness of the dripping, the reactor is heated to reach 75° C. in 30 minutes for dehydration, and then is further heated to reach 125° C. so as to remove the epichlorohydrin.

When the reactor is cooled to 75° C., 200 g of ethyl acetate (extractant solvent) and 15 g of 35 wt % sodium hydroxide aqueous solution (neutralizing solution) are added for washing the product. Subsequently, the reactor is heated to reach 120° C. for refluxing and dehydration, and then the reactor is vacuumed at 10 Torr to evacuate the extract solvent, so as to obtain the phenolic epoxy resin. An epoxy equivalent of the phenolic epoxy resin in Example 4 is 312 g/equivalent, and a viscosity of phenolic epoxy resin in Example 4 is 11,000 cps.

### Example 5

The operating conditions in Example 5 are similar to the operating conditions in Example 4. The difference is that the addition amount of the epichlorohydrin is 1,100 g, and the total dripping time of the first basic solution is 1.5 hours. The epoxy equivalent of the phenolic epoxy resin in Example 5 is 308 g/equivalent, and a viscosity of phenolic epoxy resin in Example 5 is 11,300 cps.

### Example 6

The operating conditions in Example 6 are similar to the operating conditions in Example 4. The difference is that the total dripping time of the first basic solution is 2 hours, the total dripping time of the second basic solution is 1.5 hours, and the extract solvent to wash the phenolic epoxy resin is methyl isobutyl ketone. The epoxy equivalent of the phenolic epoxy resin in Example 6 is 293 g/equivalent, and a viscosity of phenolic epoxy resin in Example 6 is 12,100 cps.

TABLE 2

| | | Example 4 | Example 5 | Example 6 |
|---|---|---|---|---|
| Total dripping time of first | | 2.5 | 1.5 | 2 |
| basic solution (hours) | | | | |
| Total dripping time of second | | 2 | 2 | 1.5 |
| basic solution (hours) | | | | |
| Phenolic | Epoxy equivalent | 312 | 308 | 293 |
| epoxy resin | (g/equivalent) | | | |
| | Viscosity (cps) | 11000 | 11300 | 12100 |

According to the results in Table 2, a terminal functional group of the biomass phenolic resin can be replaced with the epoxy group according to the steps S6 to S10 of the present disclosure, such that a biomass material which has properties of both epoxy resin and the phenolic resin can be obtained.

According to Examples 4 to 6, the epoxy equivalent of the phenolic epoxy resin can range from 250 g/equivalent to 350 g/equivalent, and the viscosity of the phenolic epoxy resin can range from 10,000 cps to 15,000 cps. In other embodiments, the epoxy equivalent of the phenolic epoxy resin can be integers between 250 g/equivalent to 350 g/equivalent, and the viscosity of the phenolic epoxy resin can be integers between 10,000 cps to 15,000 cps.

### Beneficial Effects of the Embodiments

In conclusion, in the phenolic epoxy resin and the method for manufacturing a phenolic epoxy resin provided by the present disclosure, by virtue of “injecting the phenolic resin, epichlorohydrin, and a surfactant into a reactor,” “adding a first basic solution for a dehydration reaction at a temperature ranging from 55° C. to 65° C.,” and “adding a second basic solution for a ring-closure reaction at a temperature ranging from 60° C. to 70° C.,” the phenol epoxy resin completely formed from biomass material can be obtained and can be used to replace the phenol epoxy resin formed from petroleum-cracking materials.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A method for manufacturing a phenolic epoxy resin, comprising:
reacting cardanol and vanillin for a polycondensation reaction at a temperature ranging from 60° C. to 90° C., so as to form a phenolic resin;
injecting the phenolic resin, epichlorohydrin, and a surfactant into a reactor, wherein the surfactant is an alcohol ether solvent;
adding a first basic solution into the reactor for a dehydration reaction at a temperature ranging from 55° C. to 65° C.; and
when an equivalent of a hydroxyl group of the phenolic resin is lower than 3% of the original equivalent of the hydroxyl group of the phenolic resin, adding a second basic solution into the reactor for a ring-closure reaction at a temperature ranging from 60° C. to 70° C., so as to obtain a phenolic epoxy resin.

2. The method according to claim 1, wherein, based on a total weight of the phenolic resin being 100 phr, an addition amount of the epichlorohydrin ranges from 400 phr to 800 phr.

3. The method according to claim 1, wherein a molecular weight of the phenolic resin ranges from 4,000 g/mol to 10,000 g/mol.

4. The method according to claim 1, wherein the surfactant is selected from the group consisting of: ethylene glycol monomethyl ether, diethylene glycol monomethyl ether, triethylene glycol monomethyl ether, diethylene glycol monoethyl ether, diethylene glycol monobutyl ether, propylene glycol monomethyl ether, and propylene glycol monoethyl ether.

5. The method according to claim 1, wherein the first basic solution is added in a dropwise manner, and a total dripping time of the first basic solution ranges from 1.5 hours to 3.5 hours.

6. The method according to claim 1, wherein the second basic solution is added in a dropwise manner, and a total dripping time of the second basic solution ranges from 1 hour to 2.5 hours.

7. The method according to claim 1, wherein, after the dehydration reaction, the reactor is heated to over 65° C., and a pressure in the reactor ranges from 5 Torr to 400 Torr for dehydration.

8. The method according to claim 1, wherein, after the ring-closure reaction, the reactor is heated to over 75° C., and a pressure in the reactor ranges from 5 Torr to 400 Torr for dehydration.

9. The method according to claim 8, wherein, after the dehydration, the epichlorohydrin remained in the reactor is removed at a temperature ranging from 120° C. to 130° C.

10. The method according to claim 9, wherein, after removing the epichlorohydrin, an extract solvent is added into the reactor at a temperature ranging from 70° C. to 80° C., so as to obtain the phenolic epoxy resin.

11. The method according to claim 10, wherein the extract solvent is selected from the group consisting of: ethyl acetate, toluene, and methyl isobutyl ketone.

12. The method according to claim 1, wherein an equivalent of an epoxy group of the phenolic epoxy resin ranges from 250 g/equivalent to 350 g/equivalent.

13. The method according to claim 1, wherein a viscosity of the phenolic epoxy resin ranges from 10,000 cps to 15,000 cps.

14. A phenolic epoxy resin formed from the method as claimed in claim 1.
